(19) United States
(12) Patent Application Publication
(10) Pub. No.: US 2021/0291933 A1
(43) Pub. Date: Sep. 23, 2021

(54) ENVIRONMENTALLY FRIENDLY BOAT HAVING A SAFETY-ENHANCING HULL STRUCTURE

(71) Applicant: CSAW Studios LLC, Ypsilanti, MI (US)

(72) Inventor: Seanan R. Holland, Ypsilanti, MI (US)

(21) Appl. No.: 17/209,546

(22) Filed: Mar. 23, 2021

Related U.S. Application Data
(60) Provisional application No. 62/993,269, filed on Mar. 23, 2020.

(51) Int. Cl. B63B 1/04; B63B 3/14; B63H 21/17; B63B 73/40; B63B 29/00; B63B 3/38; B32B 5/02; B32B 5/18; B32B 5/24

(52) U.S. Cl. CPC B63B 1/04; B32B 2260/021; B63H 21/17; B63B 73/40; B63B 29/00; B63B 3/38; B32B 5/02; B32B 5/18; B32B 5/245; B63B 2209/18; B63B 2209/20; B32B 2250/40; B32B 2605/12; B32B 2260/046; B63B 3/142

(57) ABSTRACT

A boat comprising: (a) a monolithically formed hull, the hull having a hole positioned along an upper surface of the hull above a waterline when the boat is positioned within water; and (b) a cockpit secured within the hole of the hull, wherein an exterior of the hull is free of seams directly presented to a force of moving water.

### FIELD

The present teachings generally relate to a floating vessel, and more particularly, to a boat having an improved sandwich-cored hull design configured for self-sufficiency, enhanced safety, improved maneuverability, and reduced wetted surface area.

### BACKGROUND

Boat safety has been an area of focus in the marine industry over the years. Crews partaking on voyages may encounter treacherous waters and face difficult situations, often resulting from the environment. For example, in treacherous waters a boat may face high force impact along a hull or top deck of the boat, causing damage to the boat or even causing injury to crewmembers. In these treacherous conditions, a waterline may often rise significantly, thereby reaching a much higher point on the hull of the boat than would otherwise occur in calmer conditions. If a boat is caught in treacherous conditions and becomes damaged, a crew may be unable to easily steer or maneuver the boat, resulting in the boat potentially being stranded at sea, or worse.

One particular threat to a vessel is “tripping.” Tripping occurs when a waterline may rise above an edge of the boat, or alternatively, the boat may roll enough to cause the edge of the vessel to be submerged beneath the water. Once the “trip edge” is submerged beneath the water, the boat may roll further, potentially beyond a point of the vessel being able to self-right prior to capsizing. Because conventional vessels may often have a trip edge that almost entirely circumscribes the perimeter of the hull along a secondary bond, the vessel is at increased risk of damage from treacherous seas.

An additional concern regarding safety involves a lack of protected workspace or walkways along a topside (e.g., a deck). Frequently, sailboats may only include small walkways along an outboard portion of the foredeck. These walkways may frequently be so narrow that only one crewmember may perform needed work on the foredeck. Even then, due to the low height above water and outboard location of the walkways, the crewmember(s) may be subject to pummeling seas.

Due to the aforementioned problems, there remains a need for a boat that is safer to operate. What is needed is a boat having a hull design that facilitates a trip edge being located farther inboard and above a waterline when compared to a conventional vessel. There remains a need for a boat that may withstand a higher impact force from the water during operation. What is needed is a boat having a substantially monolithically formed hull to substantially decrease weak points along the hull. There remains a need for a boat having a more protected work area along a top deck of the boat. What is needed is a boat having a central walkway to allow for crewmembers to easily and more safely walk along the boat.

At the time of this writing, estimates are that less than 2% of vessels incorporate electric motors for propulsion. Conventional sailing vessels large enough to require auxiliary propulsion are almost always fitted with diesel engines. Placement of such an engine may typically dictate limitations on placement of other devices and functionality on the boat. Therefore, what is needed is a vessel that is designed from its infancy stages that incorporates (a) permanently mounted electric motor(s).

In addressing the need for safety and ruggedness, conventional boats are often designed with a full keel that induces significant drag, thereby decreasing the boat's speed and ability to sail away from treacherous weather. Hulls designed with full keels may also have less maneuverability than fin-keeled boats. What is needed is a rugged hull and keel that have reduced wetted surface and sufficient ballast, but that maintain a higher level of maneuverability. What is needed is a keel involving a forward and aft skeg connected by a ballast bulb.

Additionally, conventional sailing vessels may often rely on auxiliary engines for electricity. Placement of such an engine may typically dictate limitations on placement of other devices and functionality on the boat, largely because that engine must also provide propulsion. Therefore, what is needed is a vessel that is designed from its infancy stages that incorporates permanently mounted and/or stowable solar panels, permanently mounted and/or stowable wind generators, permanently mounted and/or stowable water-driven generators, or a combination thereof.

In addressing the above issues of safety, ruggedness, and self-sufficiency, the vessel's surface area above the waterline may increase. For this and other vessels, higher area above the waterline is generally not desirable as it is a source of drift away from a desired course line. What is needed is a vessel which has a steering surface both forward and aft of the center of gravity of the boat. What is needed is a vessel that has steerable auxiliary propulsion capable of offsetting the boat's leeward drift without risking fuel that may be needed in an emergency.

### SUMMARY

The present teachings meet one or more of the present needs by providing a boat comprising: (a) a monolithically formed hull, the hull having a hole positioned along an upper surface of the hull above a waterline when the boat is positioned within water; and (b) a cockpit secured within the hole of the hull; wherein an exterior of the hull is largely free of seams directly presented to a force of moving water.

The present teachings meet one or more of the present needs by providing a boat, wherein: the hull, top-sides, and foredeck are a one-piece, seamless structure; the hull includes a contoured outer surface having tumblehome extending above a waterline and towards a center axis of the boat; the boat includes a central walkway extending between the cockpit and a bow of the boat, and the tumblehome extends inwardly toward the walkway to form a substantially vertical lip along opposing sides of the walkway; the hull further includes a keel having a forward skeg and a rearward skeg connected by a bulb extending therebetween; the forward skeg and rearward skeg, or portions thereof, are monolithically formed with the hull in a seamless manner; a perimeter of a cutout is formed by the forward keel, the rearward keel, and the ballast bulb, and a pair of motors are positioned within the cutout and secured to the hull; the pair of motors includes a fixed motor and a steerable motor, or a combination thereof, and wherein either or both motors may be configured to function as a generator; a solar panel is secured along an exterior surface of the foredeck tumblehome; a pod is disposed over the cockpit to enclose the cockpit; a railing extends around an outer periphery of the walkway; the hull is a sandwich-cored structure having an inner structural layer and an outer structural layer, and a stiffening layer is disposed between the inner structural layer and the outer structural layer; the inner structural layer and the outer structural layer are formed from inert, curable, or hybrid of inert and curable materials, such as resin impregnated fiberglass matrix or other heat, light, or chemically cured materials; the stiffening layer is formed from soft, hard, inert, or curable material; a walkway is homogenously formed within the hull free of joints; the hull is free of any secondary bonds, except around one relatively small and protected orifice; the boat further includes a rudder positioned between the stern of the boat and the rearward keel; the contoured surface of the hull is a continuous contoured surface extending around the cockpit substantially free of flat portions; the boat further comprises a wind turbine configured to attach to a mast secured to the hull; or a combination thereof.

The present teachings meet one or more of the present needs by providing a boat, wherein: the boat is environmentally friendly and self-sufficient so that the boat is powered by the wind, solar panel, wind turbine, motor-generators or combination thereof, and may therefore be operated largely free of petroleum-based fuel; the inner structural layer forms a cavity within the hull; a shape of the hull is formed by forming the inner structural layer around an inflatable plug in an inflated state, and once the hull is completed, the plug is deflated and removed through the hole; the tumblehome extending inwardly towards the walkway creates a recess along the walkway to promote safe footing for crew and passengers along the walkway; a portlight is positioned along the lip and inwardly turned away from a direct force of water impacting the hull; or a combination thereof. Moreover, the present teachings provide for an energy storage unit and/or device, such as a battery, being located in the hull of the boat, such as within the ballast bulb.

The present teachings also meet one or more of the present needs by providing: a boat that is safer to operate; a boat having a hull design that facilitates a trip edge being located farther inboard and above a waterline when compared to a conventional vessel; a boat that may withstand a higher impact force from the water during operation; a boat having a monolithically formed hull to substantially decrease weak points along the hull; a boat having a larger operating area along a top deck of the boat; a boat having a central walkway to allow for crewmembers to easily and safely walk along a top deck of the boat; a boat having better maneuverability and operation in treacherous conditions; a boat having one or more motors , one or more generators, or both to facilitate further self-sufficiency and control of the boat; a vessel that is designed from its infancy stages that incorporates permanently mounted and/or stowable solar panels, permanently mounted and/or stowable wind generators, permanently mounted and/or stowable water-driven generators, or a combination thereof; or a combination thereof.

### BRIEF DESCRIPTION OF THE DRAWINGS

FIG. 1 is a perspective view of a boat in accordance with the present teachings.

FIG. 2 is a perspective view of the boat of FIG. 1 with the rig not shown.

FIG. 3A is a perspective view of the boat of FIG. 2 having a wind turbine mounted to a mast and railing of the boat.

FIG. 3B is a perspective view of the boat of FIG. 3A having the wind turbine mounted in a retracted position to the railing.

FIG. 4 is a front view of the boat of FIG. 2.

FIG. 5 is an exploded perspective view of a boat in accordance with the present teachings.

FIG. 6 is cross-section 6-6 of the hull of FIG. 5.

FIG. 7A is a rear view of a boat in the water in an upright position.

FIG. 7B is a rear view of the boat of FIG. 7A in a rolled position.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a boat. The boat may be any type of boat. The boat may be a sailboat, motorboat, catamaran, fishing boat, center console boat, deck boat, cabin cruiser, or a combination thereof. It is envisioned that the teachings herein advantageously improve the safety and operability of the boat. For example, the teachings herein may decrease tripping of the boat, decrease damage or deformation of the boat, improve crewmember safety during operation of the boat, or a combination thereof.

The boat may include a hull. The hull may define a main body of the boat. The hull may function to contact water during operation of the boat. The hull may function to support the boat and maintain a substantially upright position of the boat when in the water. The hull may receive most or all of the impact from the water during operation. For example, in treacherous conditions, the hull may be impacted by strong waves or currents that may potentially damage the hull. Damage may result in cracks, bends, delaminination, or holes in the hull, resulting in the boat potentially taking on water. As such, it is desired to incorporate a hull design that may alleviate some or most of the risk of damage during operation.

To improve the safety of the boat, the hull may include a monolithically formed design as described in further detail below. The design of the hull may substantially decrease joints, connection points, bonds, or a combination thereof along the hull, between the hull and other portions of the boat, or both. One particular improvement may be that the hull includes a substantially contoured outer portion that extends above a waterline when the boat is placed in water to narrow the ship's hull (i.e., the tumblehome). Due to the contoured hull, the hull may extend further inboard before forming a bond with other portions of the boat, such as a deck, walkway, cockpit, etc. Because the bonds formed with hull are further inboard and farther above the waterline when compared to a conventional vessel, the bonds are substantially protected from impact from the water. Thus, the design herein advantageously improves the structural integrity of the boat.

The hull of the boat may be substantially free of bonds. The hull of the boat may be entirely free of bonds or may only include a single bond. For example, the hull may be monolithically formed to include a hole in which a cockpit may be placed. As such, the hull may only be bonded to the cockpit. Additionally, the hull may even monolithically (i.e., integrally) incorporate one or more additional components of the boat that may not conventionally be formed with the hull. For example, the hull may be formed with one or more integral railings along a top deck of the boat, one or more walkways or decks, or a combination thereof.

The boat may also include a central walkway. The central walkway may provide crewmembers accessibility to various portions of the boat, may allow for safe and easy travel along the boat, may provide workspace, or a combination thereof. When compared to a conventional boat, such as a sailboat, the central walkway may provide substantially more surface area. The walkway described herein may be about 25% greater or more, about 50% greater or more, or about 100% greater or more in surface area compared to a conventional boat's walkways. The walkway described herein may be about 300% greater or less, about 200% greater or less, or about 250% greater or less in surface area compared to a conventional boat's walkways.

The walkway may be substantially linear. The walkway may taper in one or more locations. The walkway may widen in one or more locations. The walkway may be located between or along one or more railings of the hull. The walkway may be integrally formed with the hull or may be bonded to the hull. For example, the tumblehome formed by the hull may extend inboard enough to establish opposing lips along the hull. The walkway may then be placed or formed between the lips so that the lips help ensure crewmembers do not slip off the walkway. The walkway may extend between the bow and the stern of the boat. The walkway may terminate somewhere therebetween. The walkway may extend from the bow of the boat, the stern of the boat, or both, and may terminate at a cockpit of the boat. As may be gleaned from the teachings herein, the walkway may be designed based on any application to optimize the area and positioning of the walkway.

The boat described herein may also provide increased maneuverability and self-sufficiency in the water. The boat may include one or more motors. The motors may be steerable or may be fixed. The motors may help propel the boat in conjunction with, or in lieu of, sail of the boat. The motors may be AC motors, DC motors, or both. The motors may be brushless, gearless, geared, or a combination thereof. The motors may be electric, solar-powered, or both.

The motors may be located anywhere along the boat. The motors may be positioned along the hull. The boat may include one or more, two or more, three or more, or even four or more motors. The boat may include eight or fewer, six or fewer, or even four or fewer motors.

The motors may also operate as a generator for the boat. As such, the motors may advantageously help the boat be more self-sufficient during longer voyages. For example, the use of generators may help power one or more accessories of the boat. The motors and/or generators may also be solar powered to ensure environmentally friendly operation and to substantially decrease any need for the boat to rely on fuels. Thus, it is envisioned that the boat described herein may be substantially eco-friendly and self-reliant.

The motors may help steer and/or propel the boat in conjunction with the sails. The motors may supplement the propelling power generated by the sails. Accordingly, if the sails maintain a desired speed of the boat, any excess wind power available may power the generator portion of the motor. Therefore, the generator portions of the motors may then store and/or exert the converted wind power to other portions of the boat. The generator portions may also be powered by a wind turbine, solar panels, or both connected to the boat, as further described in detail below.

It is further envisioned that the boat may include one or more energy storage units to store energy generated by the motors, generators, or both. The one or more energy storage units may be standalone units that are charged separately from the motors, generators, or both. The energy storage units may be charged via a solar panel, external power source, or both. The energy storage units may be a battery unit that may power one or more devices of the boat. The one or more energy storage units may be located within the hull of the boat. For example, the energy storage units may be contained within a ballast bulb, one or more skegs (e.g., forward and/or rearwad skeg), tumblehome, or a combination thereof. Thus, it may be gleaned from the present teachings that the energy storage units may be located in any desired location to balance packaging needs against energy storage and ballast needs. If energy storage needs are prioritized, then wetted area of the hull may increase. If reducing the wetted area of the hull is prioritized, then energy storage may be reduced. Moreover, the energy storage units may be contained within a portion of the hull that may beneficially prevent water from contacting the energy storage units, thereby preventing and/or reducing damage to the storage units.

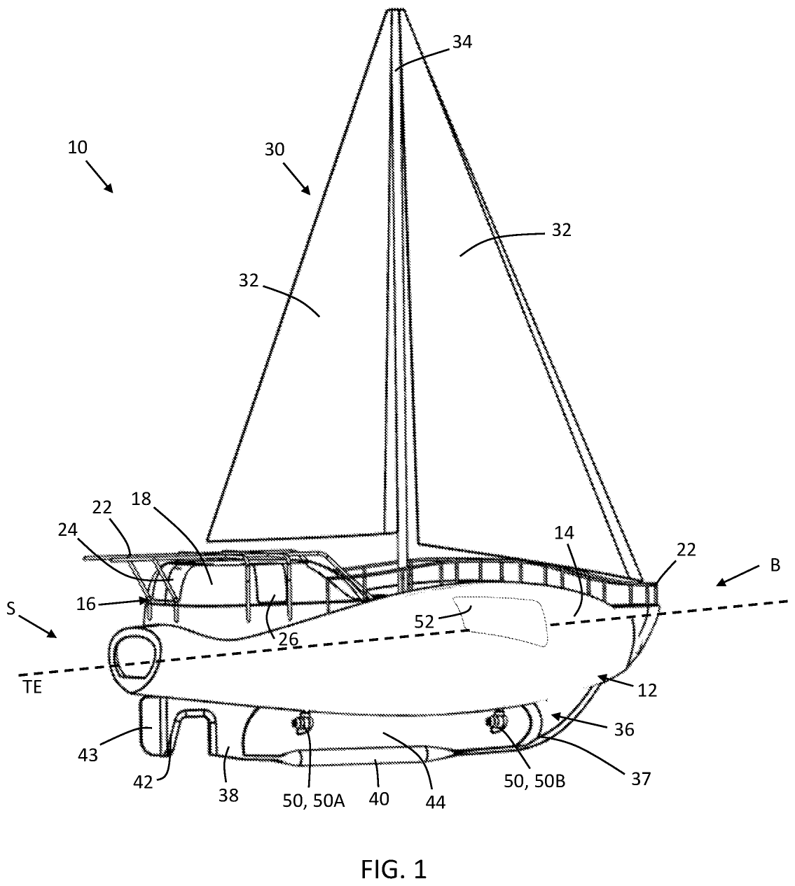

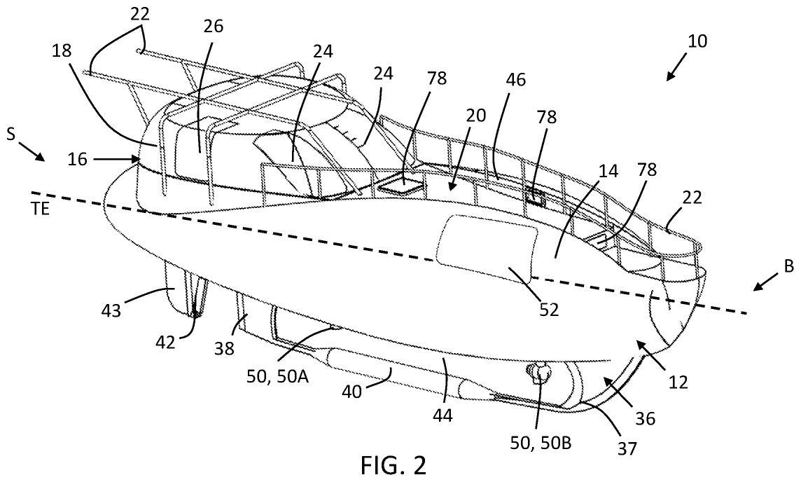

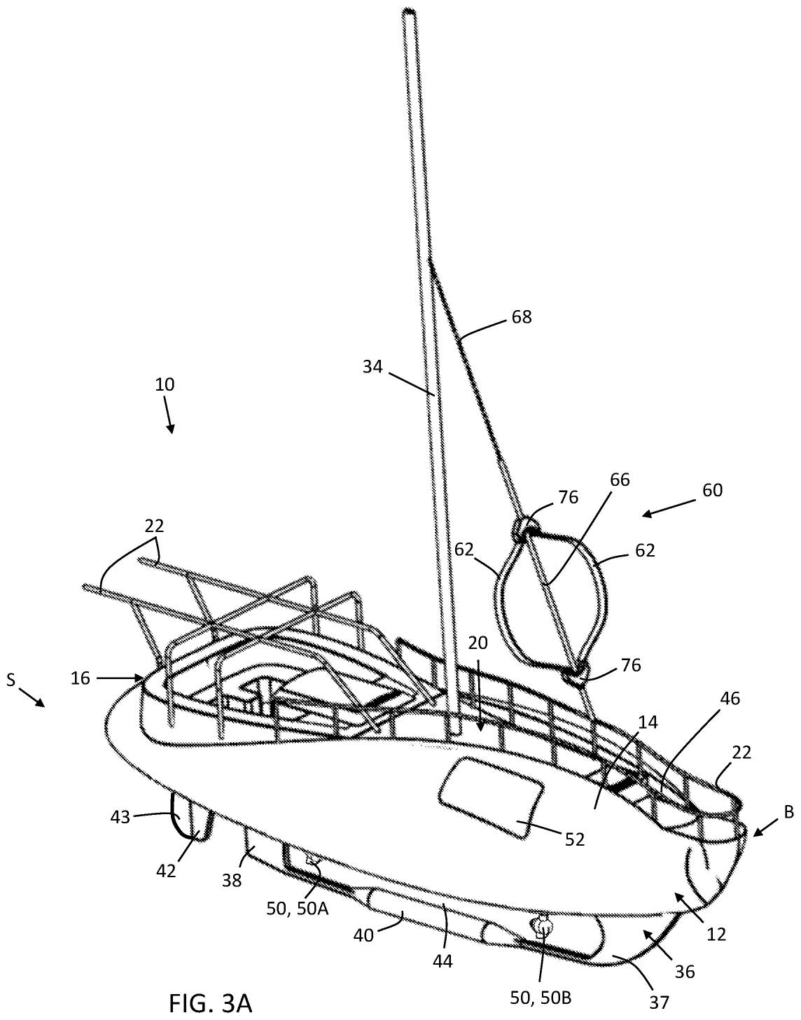

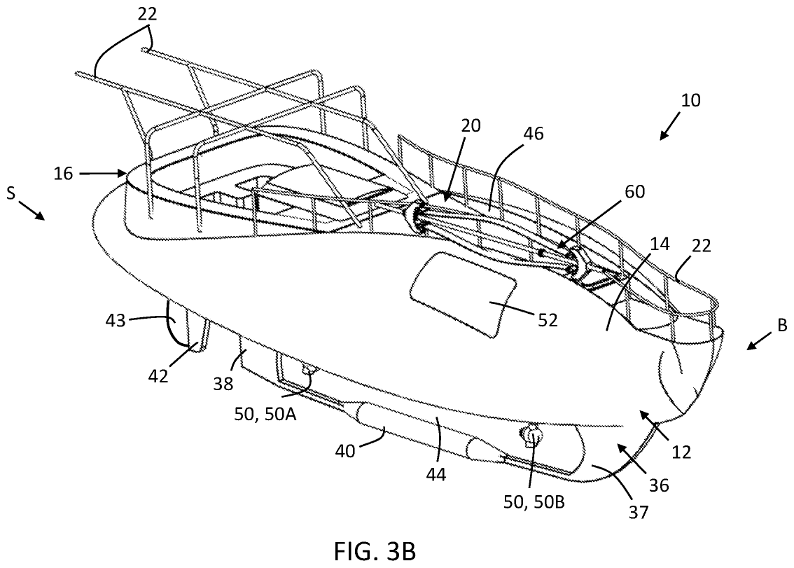

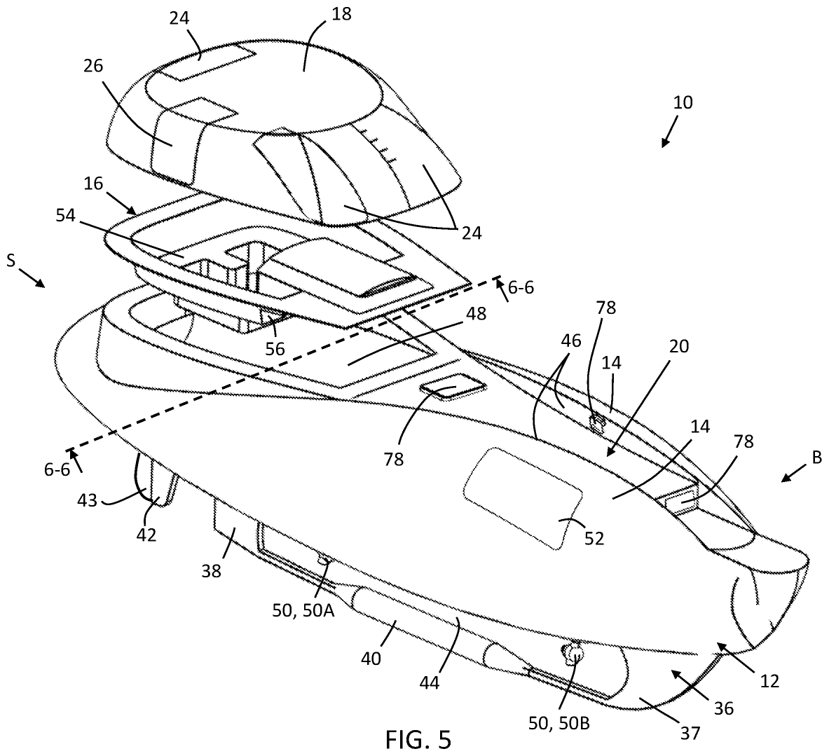

Turning now to the figures, FIG. 1 illustrates a perspective view of a boat 10. The boat 10 includes a rig 30 secured to a hull 12 of the boat 10. The rig 30 includes a mast 34 extending vertically away from the hull 12 to support a pair of sails 32 secured to the mast 34, thereby allowing the sails 32 to interact with a force of the wind and help propel the boat 10 in a desired direction. As illustrated, railings 22 are disposed along an upper portion of the hull 12 to at least partially surround a walkway (not shown; see FIGS. 2 and 3) of the boat 10, a cockpit 16 of the boat, or both. The railings 22 may extend from the stern (S) of the boat 10 to the bow (B) of the boat 10 or may terminate somewhere therebetween. The railings 22 may also provide a support surface to secure one or more additional items to a portion of the boat. Thus, it is contemplated that the railings 22 may provide a handrail for one or more operators of the boat 10 while also providing a securing means to mount or store additional items, such as a wind turbine or a solar panel 52 (see FIGS. 3A and 3B). The cockpit 16 is positioned within a hole of the hull 12 so that the connection between the cockpit 16 and the hull 12 is positioned above a waterline when the boat 10 is placed in the water (see FIG. 5). A bond or connecting portion between the hull 12 and the cockpit 16 may be higher (i.e., farther above a waterline) and/or of less circumference than on a conventional boat. A pod 18 may be disposed over the cockpit 16 to partially or fully enclose the cockpit 16 and protect an interior of the cockpit 16 from environmental degradation due to moisture, debris, ultraviolet (UV) rays, or a combination thereof. The pod 18 may also protect occupants from sun, wind, waves, or a combination thereof. The pod 18 may also include one or more windows 24, one or more hatches 26, or both. The hatches 26 may provide an access point for ingress and/or egress from the cockpit 16 onto the walkway of the boat 10.

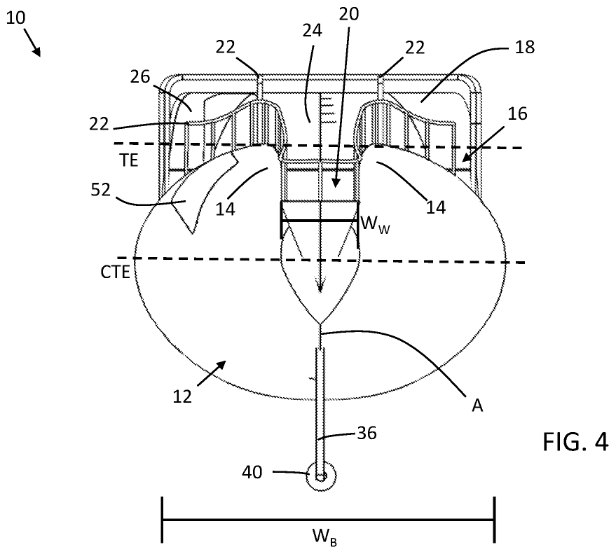

As shown, the hull 12 may include a substantially contoured exterior surface that extends from below the waterline up to the walkway well above the waterline. The hull 12 may include a tumblehome 14 reaching substantially above the waterline and connecting the hull 12 to an upper portion of the boat 10, including the walkway. The area of the high tumblehome 14, which may be integrally (i.e., monolithically) formed with the hull 12, would serve to decrease the likelihood of “tripping” the boat 10 in treacherous waters. As such, it is contemplated that a trip edge (TE) of the boat 10 may lie substantially higher and further inboard (i.e., out of the water and closer to the walkway and/or cockpit 16) when compared to a conventional boat. Once a conventional boat rolls enough to submerge a conventional trip edge (CTE), the presence of the conventional trip edge (CTE) may facilitate capsize or further roll, possibly beyond the point of self-righting the boat. Therefore, as described in the teachings herein, it may be advantageous to reduce, remove, relocate, or a combination thereof any edges on which the boat 10 might trip in treacherous waters (see FIG. 4).

The hull 12 further includes a keel 36. The keel 36 includes a forward skeg 37 and a rearward skeg 38. The forward skeg 37 and the rearward skeg 38 are connected by a ballast bulb 40 extending therebetween. As discussed above, the ballast bulb 40 may contain one or more energy storage units, such as a battery, to power one or more items and/or devices of the boat 10. The interconnected skegs 37, 38 may form a cutout 44 that at least partially houses a pair of motors 50. As illustrated, a fixed motor 50A may be positioned closer to the stern (S) of the boat 10 while a steerable motor 50B may be positioned closer to the bow (B) of the boat 10. It should be noted that the fixed motor 50A and the steerable motor 50B may be positioned anywhere within the cutout 44. For example, the fixed motor 50A may be positioned closer to the bow (B) of the boat 10 relative to the steerable motor 50B. Either or both motors 50 may be incorporated integrally in a skeg or portion of the keel. In addition to their function as motors, either or both motors 50 may be configured as a generator. The motors 50 may help drive and steer the boat 10 in conjunction with, or in lieu of, the sails 32. The hull 12 may also include a rudder 43 mounted on a rudder skeg 42 positioned near the stern (S) of the boat 10 to further improve steering of the boat 10. Moreover, since the hull 12 may have an increased surface space above the waterline and near the walkway 20 due to the high tumblehome 14 extending upward and inward toward the walkway 20, one or more solar panels 52 may be secured directly to the hull 12 (e.g., on the tumblehome 14), may be monolithically integrated with the hull 12 (e.g., integrally formed with the tumblehome 14), or both. However, it is also contemplated that solar panels 52 may be mounted elsewhere along the boat 10, such as along one or more of the railings 22. Therefore, it may be gleaned from the present teachings that the boat 10 described herein may be self-sufficient in that the solar panels 52 may provide power to the boat 10 resulting in reduced or zero need for secondary fuels.

FIGS. 2 illustrates a perspective view of the boat 10 of FIG. 1 with the rig 30 removed for further clarity. The boat 10 includes a hull 12. Railings 22 are disposed along an upper portion of the hull 12 to at least partially surround a walkway 20 of the boat 10, a cockpit 16 of the boat 10, or both. The railings 22 may extend from the stern (S) of the boat 10 to the bow (B) of the boat 10 or may terminate somewhere therebetween. The railings 22 may also provide a support surface to secure one or more additional items to a portion of the boat 10. The cockpit 16 is positioned within a hole of the hull 12 so that the connection between the cockpit 16 and the hull 12 is positioned above a waterline when the boat 10 is placed in the water (see FIG. 5). A bond or connecting portion between the hull 12 and the cockpit 16 may be higher (i.e., farther above a waterline) and/or of less circumference than on a conventional boat. A pod 18 may be disposed over the cockpit 16 to partially or fully enclose the cockpit 16 and protect an interior of the cockpit 16 from environmental degradation due to moisture, debris, ultraviolet (UV) rays, or a combination thereof. The pod 18 may also include one or more windows 24, a hatch 26, or both. As shown, the hull 12 may include a substantially seamless and contoured exterior surface that extends from below the waterline up to the walkway 20. The hull 12 may include a tumblehome 14 positioned substantially above the waterline and connecting the hull 12 to an upper portion of the boat 10, including the walkway 20. The area of high tumblehome 14 may be integrally (i.e., monolithically) formed with the hull 12, thereby eliminating a secondary bond between the walkway 20 and the hull 12 that is directly exposed to a force of the water. As shown, the tumblehome 14 turns inwardly towards the walkway 20 and forms a lip 46 so that any bond between the tumblehome 14 (and thus the hull 12) and the walkway 20 is inwardly turned away from direct force from the water. Therefore, it is envisioned that the boat 10 described herein may have substantially improved structural integrity since any weak point formed from a secondary bond between the hull 12 and other portions of the boat 10 is free of direct forces from the water. As a result of the design described herein, one or more portlights 78 may be positioned along the lip 46, the walkway 20, or both free of impact of a direct force from the water. It should also be noted that while one or more portlights 78 are shown inboard on the boat 10, one or more additional portlights 78 may be positioned along an outboard surface of the tumblehome 14 due to the increased surface of the hull 12. In addition to improved structural integrity, and as discussed regarding FIG. 1, the tumblehome 14 may decrease the likelihood of “tripping” the boat 10 in treacherous waters, whereby the boat 10 may capsize when the boat 10 is turned sideways beyond a trip edge (TE) of the hull 12. As illustrated, the tumblehome 14 extends high above the waterline and inward toward the walkway 20 to significantly narrow the hull 12 as a distance from the waterline increases (see FIG. 4). As a result of the tumblehome 14 design, a secondary bond between the hull 12 and the walkway 20 (if one exists) and an edge of the hull 12 are both protected from the direct force of the moving water, thereby substantially decreasing the likelihood of tripping.

The hull 12 further includes a keel 36. The keel 36 includes a forward skeg 37 and a rearward skeg 38. The forward skeg 37 and the rearward skeg 38 are connected by a ballast bulb 40 extending therebetween. The interconnected skegs 37, 38 may form a cutout 44 that at least partially houses a pair of motors 50. As illustrated, a fixed motor 50A may be positioned closer to the stern (S) while a steerable motor 50B may be positioned closer to the bow (B). It should be noted that the fixed motor 50A and the steerable motor 50B may be positioned anywhere within the cutout 44. For example, the fixed motor 50A may be positioned closer to the bow (B) of the boat 10 relative to the steerable motor 50B. Either or both motors 50 may be incorporated integrally in a skeg or portion of the keel 36. In addition to their function as motors, either or both motors 50 may be configured as a generator. The motors 50 may help drive and steer the boat 10 in conjunction with, or in lieu of, the sails 32.

The hull 12 may also include a rudder 43 mounted on a rudder skeg 42 positioned near the stern (S) of the boat 10 to further improve steering. Moreover, since the hull 12 may have an increased surface space above the waterline and near the walkway 20 due to the high tumblehome 14 extending upward and inward toward the walkway 20, one or more solar panels 52 may be secured directly to the hull 12 (e.g., the tumblehome 14), may be monolithically integrated with the hull 12 (e.g., integrally formed with the tumblehome 14), or both. However, it is also contemplated that the solar panels 52 may be mounted elsewhere along the boat 10, such as along one or more of the railings 22. Therefore, it may be gleaned from the present teachings that the boat 10 described herein may be self-sufficient in that the solar panels 52 may provide power to the boat 10 free of secondary fuels.

FIGS. 3A and 3B illustrate a perspective view of the boat 10 of FIG. 2 having a wind turbine 60. The boat includes a hull 12. Railings 22 are disposed along an upper portion of the hull 12 to at least partially surround a walkway 20 of the boat 10, a cockpit 16 of the boat 10, or both. The railings 22 may extend from the stern (S) of the boat 10 to the bow (B) of the boat 10 or may terminate somewhere therebetween. The railings 22 may also provide a support surface to secure one or more additional items to a portion of the boat 10. The cockpit 16 is positioned within a hole of the hull 12 so that the connection between the cockpit 16 and the hull 12 is positioned above a waterline when the boat 10 is placed in the water (see FIG. 5). The hull 12 may include a tumblehome 14 positioned substantially above the waterline and connecting the hull 12 to an upper portion of the boat 10, including the walkway 20. The area of high tumblehome 14 may be integrally (i.e., monolithically) formed with the hull 12, thereby eliminating a secondary bond between the walkway 20 and the hull 12 that is directly exposed to a force of the water. As shown, the tumblehome 14 turns inwardly towards the walkway 20 and forms a lip 46 so that any bond between the tumblehome 14 (and thus the hull 12) and the walkway 20 is inwardly turned away from direct force from the water.

The hull 12 further includes a keel 36. The keel 36 includes a forward skeg 37 and a rearward skeg 38. The forward skeg 37 and the rearward skeg 38 are connected by a ballast bulb 40 extending therebetween. The interconnected skegs 37, 38 may form a cutout 44 that at least partially houses a pair of motors 50. As illustrated, a fixed motor 50A may be positioned closer to the stern (S) while a steerable motor 50B may be positioned closer to the bow (B). It should be noted that the fixed motor 50A and the steerable motor 50B may be positioned anywhere within the cutout 44. For example, the fixed motor 50A may be positioned closer to the bow (B) of the boat 10 relative to the steerable motor 50B. In addition to their function as motors, either or both motors 50 may also be a generator. Either or both motors 50 may be incorporated integrally in a skeg or portion of the keel. The hull 12 may also include a rudder 43 mounted on a rudder skeg 42 positioned near the stern (S) of the boat 10 to further improve steering.

Moreover, since the hull 12 may have an increased surface space above the waterline and near the walkway 20 due to the high tumblehome 14 extending upward and inward toward the walkway 20, one or more solar panels 52 may be secured directly to the hull 12 (e.g., the tumblehome 14), may be monolithically integrated with the hull 12 (e.g., integrally formed with the tumblehome 14), or both.

As shown in FIG. 3A, a wind turbine 60 is secured to the railing 22 of the boat 10. It should be noted that the sails may be furled to allow the wind turbine 60 adequate space for operation. The wind turbine 60 may include a central shaft 66 mounted to, and extending from, the railing 22. A terminal end of the shaft 66 is connected to a cable 68 secured to the mast 34 so that the wind turbine 66 extends at least partially over the walkway 20. Once mounted, blades 62 of the wind turbine 60 connected to the shaft 66 via connectors 76 move based on the wind to generate power. The generated power may then be used to power the boat or its accessories. It should be noted that while a specific wind turbine 60 configuration has been illustrated, various configuration and mounting schemes may be used with the boat 10 to provide power in addition to the solar panels 52.

As shown in FIG. 3B, when the wind turbine 60 is not in use, it may be secured in a retracted state to one or more of the railings 22. The wind turbine 60 may be secured using any desired fastening mechanisms. However, it should be noted that the wind turbine 60 may also be stored unexposed to the elements and not connected to the railings 22. As shown, the wind turbine 60 may be easily mounted in an operational position to the railing 22 and mast 34 and retracted when not in use without disassembling any portion of the boat 10. For example, the sails may simply be furled to provide sufficient operational space for the wind turbine 60 to rotate within the wind.

FIG. 4 illustrates a front view of the boat 10 of FIG. 2. The boat 10 includes a hull 12. Railings 22 are disposed along an upper portion of the hull 12 to at least partially surround a walkway 20 of the boat 10, a cockpit 16 of the boat 10, or both. The railings 22 may extend from the stern of the boat 10 to the bow of the boat 10 or may terminate somewhere therebetween. The railings 22 may also provide a support surface to secure one or more additional items to a portion of the boat. As illustrated, the walkway 20 may extend substantially along a central axis (A) relative to a width (W_{B}) of the boat 10 from the bow to the stern (See FIGS. 1 and 2). Relative to a conventional boat, the walkway 20 may provide an operator significantly increased space to maneuver, provide a location of the boat that is safer and more functional for most tasks, or both. Additionally, due to the recessed design relative to the hull 12, the walkway 20 may also provide safer footing for a crew member. For example, a conventional boat may only include small side decks near an outer edge of the hull, making it difficult for an operator to maneuver along the hull. A pod 18 may be disposed over a cockpit (not shown) to partially or fully enclose the cockpit and protect an interior of the cockpit 16 from environmental degradation due to moisture, debris, ultraviolet (UV) rays, or a combination thereof (see FIG. 5). The pod 18 may also include one or more windows 24, a hatch 26, or both. As shown, the hull 12 may include a substantially seamless and contoured convex exterior surface that extends from below the waterline up to the walkway 20. The hull 12 may include a tumblehome 14 positioned substantially above the waterline and connecting the hull 12 to an upper portion of the boat 10, including the walkway 20. The area of the high tumblehome 14 may be integrally (i.e., monolithically) formed with the hull 12, thereby eliminating a secondary bond between the walkway 20 and the hull 12 that is exposed to a force of the water. As shown, the tumblehome 14 extends high above the waterline and inward toward the walkway 20 so that any bond between the tumblehome 14 (and thus the hull 12) and the walkway 20 is inwardly turned away from direct force from the water and forms a lip (see FIGS. 2, 3A, and 3B). Therefore, it is envisioned that the boat 10 described herein may have substantially improved structural integrity since any weak point formed from a secondary bond between the hull 12 and other portions of the boat 10 is free of direct forces from the water.

In addition to improved structural integrity, the tumblehome 14 may decrease “tripping” the boat 10 in treacherous waters, whereby the boat 10 may capsize when the boat 10 is turned sideways beyond a trip edge (TE) of the hull 12. As illustrated, the tumblehome 14 design significantly narrows a width of the hull near the walkway (W_{W}) in comparison to a maximum width of the hull (W_{B}), thereby significantly narrowing the hull 12 as a distance from the waterline increases. As a result of this design, an edge (i.e., the lip) of the hull 12 formed near the walkway 20 is protected from the direct force of the moving water, thereby substantially decreasing the likelihood of tripping and establishing a trip edge (TE) of the boat 10 that is positioned significantly higher above the waterline when compared to a conventional boat trip edge (CTE). In comparison, once a conventional boat rolls enough to submerge the conventional trip edge (CTE), the presence of the conventional trip edge (CTE) may facilitate capsize or further roll, possibly beyond the point of self-right the boat. Therefore, as described herein, it may be advantageous to reduce, remove, relocate, or a combination thereof any edges on which the boat 10 may trip in treacherous seas.

The hull 12 further includes a keel 36. The keel 36 includes a forward skeg and a rearward skeg (not shown) connected by a ballast bulb 40 extending therebetween. Additionally, since the hull 12 may have an increased surface space above the waterline and near the walkway 20 due to the high tumblehome 14 extending upward and inward toward the walkway 20, one or more solar panels 52 may be secured directly to the hull 12 (e.g., the tumblehome 14), may be monolithically integrated with the hull 12 (e.g., integrally formed with the tumblehome 14), or both.

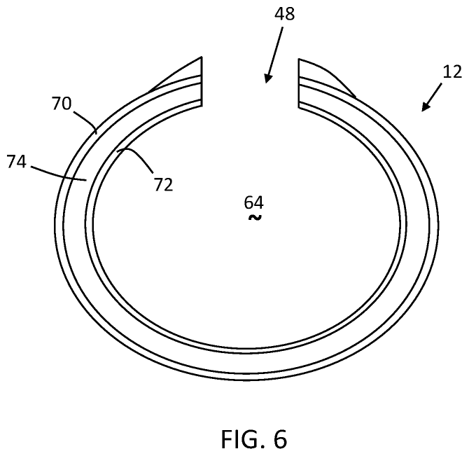

FIG. 5 illustrates an exploded perspective view of a partial boat 10. The rig and railings of the boat have been removed for further clarity (see FIG. 1). The boat 10 includes a hull 12. A walkway 20 is disposed along a central portion of the hull 12 and may extend substantially along a length of the boat from the bow (B) of the boat to the stern (S). A cockpit 16 is positioned within a hole 48 of the hull 12 so that the connection between the cockpit 16 and the hull 12 is positioned above a waterline when the boat 10 is placed in the water. The cockpit 16 may include a step 56 and/or a bench 54 for accessing an interior of the cockpit 16, for sitting within the cockpit 16, or both. A pod 18 may be disposed over the cockpit 16 to partially or fully enclose the cockpit 16 and protect an interior of the cockpit 16 from environmental degradation due to moisture, debris, ultraviolet (UV) rays, or a combination thereof. The pod 18 may also protect occupants from sun, wind, waves, or a combination thereof. The pod 18 may also include one or more windows 24, a hatch 26, or both. As shown, the hull 12 may include a substantially seamless and contoured exterior surface that extends from below the waterline up to the walkway 20 and may be made from a single piece (see FIG. 6). The hull 12 may include a tumblehome 14 positioned substantially above the waterline and connecting the hull 12 to an upper portion of the boat 10, including the walkway 20. The tumblehome 14 may be integrally (i.e., monolithically) formed with the hull 12, thereby eliminating a secondary bond between the walkway 20 and the hull 12 that is exposed to a force of the water. As shown, the tumblehome 14 extends above the waterline and turns inwardly towards the walkway 20, thereby forming a lip 46 around the walkway 20 so that any bond between the tumblehome 14 (and thus the hull 12) and the walkway 20 is inwardly turned away from direct force from the water. As a result of the design described herein, one or more portlights 78 may be positioned along the lip 46, the walkway 20, or both free of impact of a direct force from the water. It should also be noted that while one or more portlights 78 are shown inboard on the boat 10, one or more additional portlights 78 may be positioned along an outboard surface of the tumblehome 14 due to the increased surface of the hull 12.

The hull 12 further includes a keel 36. The keel 36 includes a forward skeg 37 and a rearward skeg 38. The forward skeg 37 and the rearward skeg 38 are connected by a ballast bulb 40 extending therebetween. The interconnected skegs 37, 38 may form a cutout 44 that at least partially houses a pair of motors 50. While either motor may be steerable or incorporated into a rudder-like steerable surface, as illustrated, a fixed motor 50A may be positioned closer to the stern (S) while a steerable motor 50B may be positioned closer to the bow (B). It should be noted that the fixed motor 50A and the steerable motor 50B may be positioned anywhere within the cutout 44. For example, the fixed motor 50A may be positioned closer to the bow (B) of the boat 10 relative to the steerable motor 50B. In addition to their function as motors, either or both motors 50 may be configured as a generator. Either or both motors 50 may be incorporated integrally in a skeg or portion of the keel 36. The hull 12 may also include a rudder 43 mounted on a rudder skeg 42 positioned near the stern (S) of the boat 10 to further improve steering. Moreover, since the hull 12 may have an increased surface space above the waterline and near the walkway 20 due to the high tumblehome 14 extending upward and inward toward the walkway 20, one or more solar panels 52 may be secured directly to the hull 12 (e.g., the tumblehome 14), may be monolithically integrated with the hull 12 (e.g., integrally formed with the tumblehome 14), or both.

FIG. 6 illustrates cross-section 6-6 of the hull 12 of FIG. 5. As illustrated, the hull 12 is formed substantially monolithically in a seamless manner using a plurality of layers, the layers of which may be homogenous or heterogenous. While manufacturing methods may vary, it is envisioned that a balloon-type plug may be used to form a shape of the hull 12. The plug may be of soft material, hard material, or a combination thereof. The plug may be of inert, curable, or inert-curable hybrid material such as a fabric woven of inert and curable fibers. The plug may be inflated to form a shape of an inner cavity 64 of the hull 12. Once inflated, a layer may be formed around the plug to create an inner structural layer 72 while accommodating a hole 48 within the hull 12. The hole 48 may later receive a cockpit 16 of the boat (see FIG. 5). An outer structural layer 70 may also be formed and may follow a general contour of the inner cavity 64. It is envisioned that any number of structural layers may be utilized to provide a sufficient structure. Once the structural layer 72 is of sufficient strength and stiffness, the plug may be deflated and removed. A layer 74 of core material may be utilized. The stiffening layer 74 may be a blow-molding and/or foaming material to form a core between the structural layers 70, 72. It should be noted that the stiffening layer 74 may also be formed from any number of other suitable materials, such as wood, fiberglass, other resins, or a combination thereof. For example, the structural layers 70, 72 may both be formed of a resin impregnated matrix, and the stiffening layer 74 may be a foam core material. Additionally, while the stiffening layer 74 may primarily stiffen the hull 12, it may also provide secondary benefits, such as insulation, vibration dampening, or both.

It is contemplated that a suitable, interactive material may be used as the plug thereby becoming the core layer 74, in which case the plug would not need to be removed. In this case, the inner-most layer of the sandwich-cored hull may be applied from within the hull cavity 64. It is contemplated that during the application of any layer, a mold or plug having any combination of properties such as hard, soft, elastic, inelastic, smooth, or rough may be used to aid in consolidating layers of resin and matrix. Such a mold may cover the preceding layers of the hull 12 either fully or partially. It is envisioned that a semi-elastic mold may be used as part of a vacuum forming process.

After the hull 12 is substantially formed, one or more additional steps of sanding and/or smoothing an exterior surface of the hull 12 may be completed. Once the hull 12 has been completed, the mold may be deflated and removed through the hole 48, thereby leaving a one-piece, seamless hull 12. It is also noted that a walkway (see FIG. 5) may be monolithically formed with the hull 12 by shaping the structural layers 70, 72 accordingly. However, the walkway may also be a secondary piece secured to the hull 12.

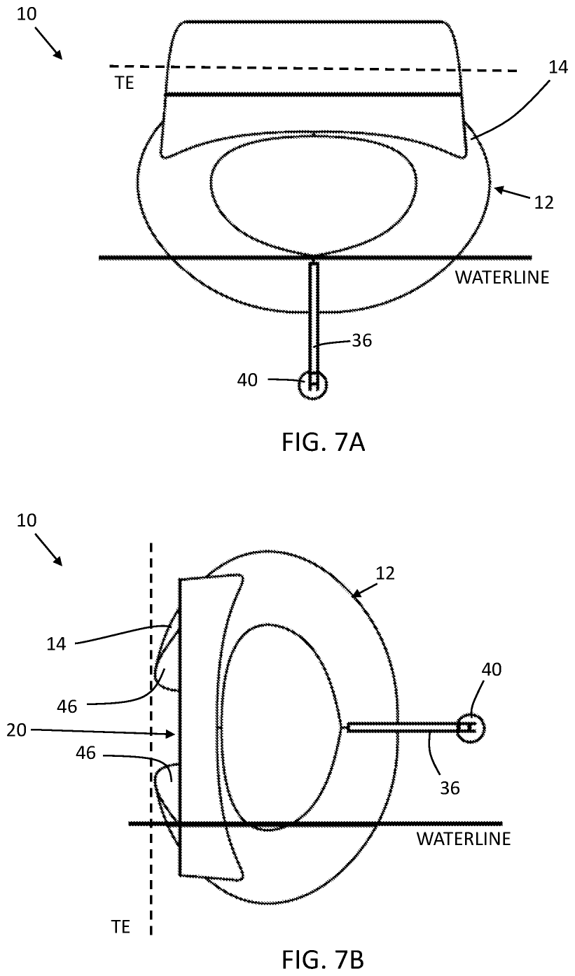

FIG. 7A and 7B illustrate a boat 10 in accordance with the present teachings. The boat 10 includes a hull 12 at least partially submerged beneath a waterline so that a keel 36 and a ballast bulb 40 are located beneath the water to balance the boat 10, steer the boat 10, or both (see FIGS. 1-5). The hull 12 further includes a tumblehome 14 that narrows and extends inboard towards a walkway 20 of the boat 10, resulting in a substantially contoured outer surface of the hull 12. As illustrated, the tumblehome 14 may form lips 46 on opposing side of the walkway 20.

As shown in FIG. 7A, when the boat 10 is in an upright position (e.g., in calm water conditions), the trip edge (TE) of the boat 10 is located substantially higher than the waterline. Additionally, as shown in FIG. 7B, the trip edge (TE) may remain above the waterline even during treacherous conditions in which the boat 10 rolls to a point where the keel 36 and the ballast bulb 40 are above the water. Therefore, the boat 10 may provide a substantially decreased likelihood of tripping since the water is unable to present itself to the lip 46 of the boat 10. Additionally, it should be noted that any secondary bond that may exist between the hull 12 and other portions of the boat 10, such as a cockpit, walkway 20, or both, may also be substantially above the waterline. Therefore, the secondary bond, if present, may have a lesser chance of damage and/or separation due to the decrease in force being applied by the water. Furthermore, it is envisioned that the secondary bond may also be reinforced and/or water resistant to further improve the structural integrity of the hull 12 and prevent damage.

### ELEMENT LIST

10 Boat
12 Hull
14 Tumblehome
16 Cockpit
18 Pod
20 Walkway
22 Railing
24 Window
26 Hatch
30 Rig
32 Sail
34 Mast
36 Keel
37 Forward Skeg
38 Rearward Skeg
40 Ballast Bulb
42 Rudder Skeg
43 Rudder
44 Cutout
46 Lip
48 Hole
50 Motor
50A Fixed Motor
50B Steerable Motor
52 Solar Panel
54 Bench
56 Step
60 Wind Turbine
62 Blade
64 Cavity
66 Shaft
68 Cable
70 Outer Structural Layer
72 Inner Structural Layer
74 Stiffening Layer
76 Connector
78 Portlight
B Bow of the Boat
S Stern of the Boat
W_{B} Width of the Boat
W_{W} Width of the Walkway
A Center Axis of the Boat
TE Trip Edge
CTE Conventional Trip Edge

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements, ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100 +1-15.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

I claim:

1. A boat comprising:
(a) a monolithically formed hull, the hull having a hole positioned along an upper surface of the hull above a waterline when the boat is positioned within water; and
(b) a cockpit secured within the hole of the hull;
wherein an exterior of the hull is free of seams directly presented to a force of moving water.

2. The boat of claim 1, wherein the hull, top-sides, and foredeck are a one-piece, seamless structure.

3. The boat of claim 1, wherein the hull includes a contoured outer surface having tumblehome extending above a waterline and towards a center axis of the boat.

4. The boat of claim 3, wherein the boat includes a central walkway extending between the cockpit and a bow of the boat, and the tumblehome extends inwardly toward the walkway to form a lip along opposing sides of the walkway.

5. The boat of claim 4, wherein the hull further includes a keel having a forward skeg and a rearward skeg connected by a bulb extending therebetween.

6. The boat of claim 5, wherein the forward skeg and rearward skeg, or portions thereof, are monolithically formed with the hull in a seamless manner.

7. The boat of claims 6, wherein a perimeter of a cutout is formed by the forward keel, the rearward keel, and the ballast bulb, and a pair of motors are positioned within the cutout and secured to the hull; and wherein an energy storage unit is located within the ballast bulb.

8. The boat of claim 7, wherein the pair of motors includes a fixed motor and a steerable motor, or a combination thereof, and wherein either or both motors may be configured to function as a generator.

9. The boat of claim 3, wherein a solar panel is secured along an exterior surface of the foredeck tumblehome.

10. The boat of claim 1, wherein a pod is disposed over the cockpit to enclose the cockpit.

11. The boat of claim 4, wherein a railing extends around an outer periphery of the walkway.

12. The boat of claim 1, wherein the hull is a sandwich-cored structure having an inner structural layer and an outer structural layer, and a stiffening layer is disposed between the inner structural layer and the outer structural layer.

13. The boat of claim 12, wherein the inner structural layer and the outer structural layer are formed from inert, curable, or hybrid of inert and curable materials, such as resin impregnated fiberglass matrix or other heat, light, or chemically cured materials.

14. The boat of claim 13, wherein the stiffening layer is formed from soft, hard, inert, or curable material.

15. The boat of claim 1, wherein a walkway is homogenously formed within the hull free of joints.

16. The boat of claim 14, wherein the hull is free of any secondary bonds, except around a single protected orifice.

17. The boat of claim 1, wherein the boat further includes a rudder positioned between the stern of the boat and the rearward keel.

18. The boat 17, wherein the contoured surface of the hull is a continuous contoured surface extending around the cockpit substantially free of flat portions.

19. The boat of claim 1, further comprising a wind turbine, wherein the wind turbine is configured to attach to a mast secured to the hull.

20. The boat of claim 19, wherein the boat is environmentally friendly and self-sufficient so that the boat is powered by the wind, solar panel, wind turbine, motor-generators or combination thereof, and may therefore be operated largely free of petroleum-based fuel.
